(19) United States
(12) Patent Application Publication
(10) Pub. No.: US 2017/0129794 A1
(43) Pub. Date: May 11, 2017

(54) WASTEWATER TREATMENT OPERATIONAL METHOD

(71) Applicant: Praxair Technology, Inc., Danbury, CT (US)

(72) Inventors: Randall B. Marx, Lisle, IL (US); Malcolm E. Fabiyi, Chicago, IL (US); Yan Shi, Shanghai (CN)

(21) Appl. No.: 15/318,405

(22) PCT Filed: Jul. 4, 2014
(86) PCT No.: PCT/CN2014/081644

§ 371 Date: Dec. 13, 2016

(51) Int. Cl. C02F 3/00; C02F 3/26

(52) U.S. Cl. CPC C02F 3/006; C02F 3/26; C02F 2203/004; C02F 2209/02; C02F 2209/08; C02F 2301/043; C02F 2209/40; C02F 2209/10

(57) ABSTRACT

A method of operating a waste water treatment facility to prevent bulking in which growth of floc forming bacteria is promoted within a selector aeration tank by controlling absorption and bio-oxidation of biodegradable soluble chemical oxygen demand by the bacteria. Absorption is controlled through measurement of a percentage removal of biodegradable soluble chemical oxygen demand and bio-oxidation is controlled through measurement of temperature corrected specific oxygen uptake rate. Both the absorption and bio-oxidation levels are controlled by decreasing the degree to which wastewater influent flow bypasses the selector aeration tank in favor of the main aeration tank when either of absorption or bio-oxidation are below targeted ranges and increasing flow rate of recycle activated sludge from the clarifier to the main aeration tank while decreasing recycle activated sludge flow rate to the selector aeration tank when absorption and bio-oxidation are above such targeted ranges.

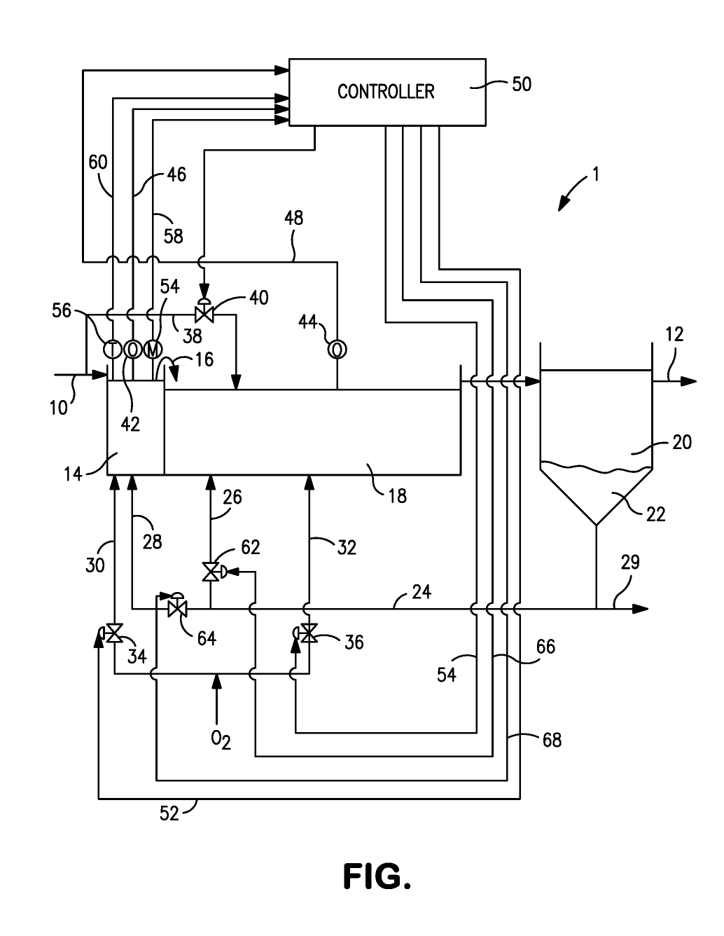

### FIELD OF THE INVENTION

The present invention relates to a method of operating a wastewater treatment facility in which aerobic conditions are maintained within a selector aeration tank and a main aeration tank located downstream of the selector aeration tank and activated sludge is recirculated from a secondary clarifier to the selector aeration tank and the main aeration tank to support bacterial treatment of biodegradable, soluble chemical oxygen demand contained within the wastewater. More particularly, the present invention relates to such a method in which formation of floc forming bacteria is promoted and therefore, sufficient settling of solids in the clarifier to allow for the discharge of a treated effluent, by maintaining an absorption level and an bio-oxidation level of the biodegradable soluble chemical oxygen demand within the selector aeration tank that will promote the formation of the floc forming bacteria.

### BACKGROUND OF THE INVENTION

Wastewater is conventionally treated to remove carbon containing compounds with the use of aerobic bacteria contained in activated sludge. Injection of oxygen into the wastewater supports action of the aerobic bacteria to decompose the carbon containing compounds into carbon dioxide and water and the production of further bacteria. In a wastewater treatment plant, typically solid wastes are allowed to settle in a primary clarifier. The effluent from the primary clarifier is then further treated in a main aeration tank into which both oxygen and activated sludge are also introduced. The resulting mixed liquor is then introduced into a secondary clarifier tank where the bacteria settle to form the activated sludge. A recycle activated sludge stream, composed of the settled activated sludge is recycled to the main aeration tank, a waste activated sludge stream is discharged for further treatment and a treated effluent is discharged from the secondary clarifier, which might sometimes require further treatment before being discharged into the environment.

A major problem in an activated sludge treatment plant is bulking where there exists a high volume of activated sludge in relation to the total weight of the sludge. As a result, the sludge will not settle rapidly enough in the secondary clarifier tank resulting in unwanted contamination of the treated effluent discharged from the clarifier with solids. This is common where the wastewater is industrially produced, for instance, from pulp and paper manufacturing. Sludge volume index is a parameter used to gauge how quickly the secondary sludge settles and how compact the sludge blanket is likely to be in the sedimentation or clarifier tank. The more quickly the sludge settles, the higher the maximum flow rate of process water that can pass through the secondary clarifier tank before unacceptable levels of suspended solids enter the effluent. Optimum flow capacity and effluent quality typically occur at a sludge volume index of between 60.0 and 80.0 mL/g. Below this range, the sludge settles so quickly that poor flocculation might result and effluent contains high levels of suspended solids. Alternatively, if the sludge volume index exceeds 150.0 mL/g, the sludge is said to be bulking and the flow capacity is reduced.

Bulking can have a large impact on the capital requirements and operating costs of a wastewater treatment facility by decreasing the capacity of the facility to treat the wastewater. A cause of bulking is the predominance of filamentous organisms (filaments), which settle slowly in the clarifier tank as compared to non-filaments or bacteria that will flocculate that are known as floc-forming bacteria. One way to mitigate bulking is to control the process in order to favor the growth of well-settling non-filaments over filaments and other organisms that promote bulking. Studies have shown that non-filaments and filaments have markedly different growth characteristics and that filamentous forms of bacteria tend to have lower maximum specific growth rates and tend to reach the maximum growth rate at a lower substrate level.

As a result of these different kinetics, one approach to the promotion of non-filament growth is to have most of the cell growth occur under very high substrate levels, where non-filaments grow faster and can predominate. To achieve most growth at a high F/M (the food to microorganism ratio, a ratio of the mass of chemical oxygen demand or biological oxygen demand per mass of solids in a reactor per day), where non-filaments predominate, yet maintain low substrate levels in the effluent, two aeration tanks can be run in series, where the first of such tanks, known as a selector aeration tank, has a higher F/M and the second tank, the main aeration tank, has much lower substrate levels because most of the food substrate is consumed in the first tank. In the selector aeration tank, the F/M is higher than in the main aeration tank because the “F”, determined by the influent flow and contaminant concentrations is at the maximum levels possible since this tank receives the untreated influent from the primary clarifier, while the mass of microorganisms, “M”, is reduced relative to the main aeration tank because the volume of the selector is smaller than the second (main) aeration tank. In this manner, the selector aeration tank can favor the growth of non-filaments and the main aeration tank can have such low substrate levels that little growth occurs even though this growth will actually favor filaments.

An example of the use of a selector aeration tank can be found in U.S. Pat. No. 3,864,246. In this patent, high levels of both dissolved oxygen and biological oxygen demand are maintained in the selector aeration tank to favor the growth of floc forming bacteria. The high levels of biological oxygen demand are achieved by maintaining a high F/M ratio in the selector aeration tank. The “F” is determined by separating insolubles by filtration through a 5 micron filter and then approximating the “F” by multiplying the soluble biological oxygen demand by 1.5. The “M” is determined by measuring the mixed liquor volatile suspending solids and then multiplying the measured result by an activity coefficient that is equal to the maximum specific oxygen uptake rate and dividing the result by a reference rate expressed as a function of temperature.

Typically, the selector aeration tank is fed with recycled activated sludge from the clarification tank and is designed to operate at an F/M of between 0.1 and 27.0 gBOD/gVSS-d, an oxygen uptake rate of between 30.0 and 600.0 mg/L/h, and a hydraulic retention time of up to 2 hours. It is to be noted that once the selector and main aeration tanks have been built there is very little flexibility in the operation of the facility. However, this lack of control can present a challenge due to deviations between design and actual influent conditions. For instance, if the F/M is too low, filamentous bulking will tend to occur. If the F/M is too high, zoogleal bulking can occur. Without active control of the soluble chemical oxygen demand, selectors are not likely to be effective in the control of bulking. For example, due to the fluctuations in load, and therefore F/M, the actual optimal size requirement of the selector can vary with time. For example, when the flow rate is relatively low, a smaller selector would be needed to maintain the target selector F/M and when the flow is high, the selector would need to be larger. However, as can be appreciated, such an approach to control bulking in a full scale plant would not be practical.

There have been several proposals that are at least more practical, than has been discussed above, to modify the selector design in an attempt to improve bulking control. In its simplest form, a selector is a single tank. However, it has been suggested to form the selector from three tanks in series to minimize back mixing and allow for a range of soluble chemical oxygen demand levels in the selectors, with the soluble chemical oxygen demand decreasing from the first to the third selector. Plug flow and sequencing batch reactors have been also been proposed. A challenge in all of these approaches is that while they increase the probability of achieving high levels of soluble chemical oxygen demand at some point in the process, they do not optimize these levels or prevent the levels of soluble chemical oxygen demand that would stimulate the growth of filaments. A more comprehensive approach in modifying the F/M in selector aeration tanks to control bulking is to implement an adjustable step-feed strategy. In this approach the mass inventory of solids in the selector (M) is maintained, while the influent load (F) to the selector is controlled by bypassing an adjustable fraction of the total influent from the selector feed to flow instead directly to the main aeration tank, to decrease the selector F/M as required. The use of this strategy allows only a decrease in the F/M to the selector as normally all influent (F) is fed to the selector. To allow increases in the selector F/M, an adjustable bypass of the recycle sludge to the main aeration tank can also be implemented. The problem with this system is that although it has the potential to be effective at controlling the relative growth rates of a pure non-filamentous bacterial culture compared to a pure filamentous culture, it has only been conducted on a laboratory scale in which critical process variables which are known to impact bulking such as temperature, influent composition and influent flow rate were all fixed. However, all of these variables can change over time resulting in the control of such a system at full-scale to be highly problematical. In particular, temperature can vary by as much as a factor of 2-3 across seasons. In this regard, even in the patent mentioned above, the measurement of the F/M quantity is not practical given that measurement of biological oxygen demand involves reacting a wastewater sample with a bacteria sample and then waiting many days for completion of the reaction. As earlier indicated, conditions within the wastewater facility can rapidly change due to environmental factors such as passing rain storms and changes in industrial production.

As will be discussed, the present invention provides a method of operating a wastewater treatment facility employing a selector in an adjustable step-feed strategy as has been discussed above that constitutes a practical method of implementing such method.

### SUMMARY OF THE INVENTION

The present invention provides a method of operating a waste water treatment facility to prevent bulking in a clarifier used in discharging a treated effluent. In accordance with such method, aerobic conditions for bacterial activity are maintained within a selector aeration tank and a main aeration tank, both located upstream of the clarifier from which activated sludge is recycled to the selector aeration tank and the main aeration tank to promote bacterial activity and a treated effluent is discharged. Formation of floc forming bacteria is promoted and therefore, sufficient settling of solids in the clarifier to allow for the discharge of the treated effluent by maintaining an absorption level and an bio-oxidation level of biodegradable, soluble chemical oxygen demand within the selector aeration tank that will promote the formation of the floc forming bacteria. The absorption level is determined by measuring removal of biodegradable soluble chemical oxygen demand in the selector aeration tank as a percentage removal of the total biodegradable soluble chemical oxygen demand removed in both the selector aeration tank and the main aeration tank. The bio-oxidation level of the biodegradable soluble chemical oxygen demand is measured by measuring temperature within mixed liquor contained in the selector aeration tank and the specific oxygen uptake rate within the selector aeration tank and correcting the specific oxygen uptake rate for non-standard temperature to obtain a temperature corrected specific oxygen uptake rate. The percentage removal of the total biodegradable soluble chemical oxygen demand is first maintained within a targeted range. After this targeted range is maintained, the temperature corrected specific oxygen uptake rate is maintained within its respective targeted range. The targeted rage of the percentage removal of the total biodegradable soluble chemical oxygen demand within the selector is between 50.0 percent and 85.0 percent and the targeted range for the temperature corrected specific oxygen uptake rate is between 18.0 and 27.0 milligrams oxygen per gram of volatile suspended solids per day at 20° C. These ranges are maintained by decreasing a by-pass flow rate of wastewater influent bypassing the selector aeration tank in favor of the main aeration tank when either of the percentage removal or the temperature corrected specific oxygen uptake rate is below either of the respective targeted ranges and increasing a first recycle flow rate of activated sludge from the clarifier to the main aeration tank while decreasing a second recycle flow rate of the activated sludge from the clarifier to the selector aeration tank when either the percentage removal or the temperature corrected specific oxygen uptake rate is above either of the respective targeted ranges.

The control provided for by the present invention allows for conditions that will prevent bulking to be ascertained and controlled in a more rapid fashion than prior art methods discussed above. As a result, the present invention allows waste water treatment to be more practically conducted in response to changes brought about by flow rates of influent and concentration of chemical oxygen demand within the waste water than in the prior art.

Preferably, the targeted range for the percentage removal rate is between 60.0 percent and 85.0 percent. Further, after each modification of either the by-pass flow rate of wastewater influent or the first recycle rate flow rate and the second recycle flow rates, a solids loading rate and a hydraulic loading rate within the clarifier can be measured and a total flow rate of recycled activated sludge from the clarifier to the main aeration tank and the selector aeration tank can then be reduced when the solids loading rate and the hydraulic loading rate are exceeded.

The temperature corrected specific oxygen uptake rate can be determined by measuring an oxygen uptake rate and mixed liquor suspended solids value within the selector aeration tank and calculating a mixed liquor volatile suspended solids value within the selector aeration tank by multiplying the mixed liquor suspended solids value by a measured ratio of volatile suspended solids to total suspended solids. A specific oxygen uptake rate within the selector aeration tank can then be calculated by dividing the oxygen uptake rate by the mixed liquor volatile suspended solids value and temperature correction can be applied for environmental temperature variation to the specific oxygen uptake rate. This correction can be effectuated by measuring temperature of the mixed liquor within the selector aeration tank and multiplying the mixed liquid volatile suspended solid value by a Van't Hoff-Arrhenius temperature correction.

The measurement of the removal of biodegradable soluble chemical oxygen demand in the selector aeration tank as a percentage removal of the total biodegradable soluble chemical oxygen demand removed in both the selector aeration tank and the main aeration tank can be accomplished by performing a mass balance measurement. In accordance with such mass balance measurement an influent stream into the wastewater treatment facility, mixed liquor within the selector aeration tank and the treated effluent stream discharged from the secondary clarifier are separately sampled and filtered to respectively obtain, first, second and third soluble chemical oxygen demand concentrations. The biodegradable soluble chemical oxygen demand removed in the selector aeration tank is determined by multiplying flow rates of a portion of the influent stream actually entering the selector aeration tank and an effluent discharged from the selector aeration tank by the first and second of the soluble chemical oxygen demands. The biodegradable soluble chemical oxygen demand removed in the wastewater treatment facility is determined by multiplying a difference between the first and third of the soluble chemical oxygen demand concentrations by a further flow rate of the influent stream and the percentage removal of the biodegradable soluble chemical oxygen demand is calculated by dividing the biodegradable soluble chemical oxygen demand removed in the selector aeration tank by the biodegradable soluble chemical oxygen demand removed in the wastewater treatment facility.

The aerobic conditions can be maintained by injecting a first oxygen containing stream into the selector aeration tank and a second oxygen containing stream into the main aeration tank where the first oxygen containing stream and the second oxygen containing stream each containing at least 90.0 percent by volume oxygen. A first dissolved oxygen concentration is measured in the selector aeration tank and a second dissolved oxygen concentration is measured in the main aeration tank. The injection rate of the first oxygen containing stream is suspended or reduced when the first dissolved oxygen concentration is greater than 1.0 mg/L and the injection of the second oxygen containing stream is suspended or reduced when the second dissolved oxygen concentration is greater than 1.0 mg/L. The oxygen uptake rate can be measured by increasing the first dissolved oxygen concentration to 3.0 mg/L. and then, suspending the injection of the first oxygen containing stream when the first dissolved oxygen concentration is at 3.0 mg/L. The rate of change of the first dissolved oxygen concentration relative to time is then measured.

### BRIEF DESCRIPTIONS OF THE DRAWINGS

While the specification concludes with claims distinctly pointing out the subject matter that Applicants regard as their invention, it is believed that the invention will be better understood when taken in connection with the accompanying drawings in which the sole FIGURE is a schematic process and instrumentation diagram of a wastewater treatment facility in accordance with the present invention.

### DETAILED DESCRIPTION

With reference to the sole FIGURE, an apparatus 1 is illustrated for accomplishing a secondary wastewater treatment process within a wastewater treatment facility in which an influent stream 10 is biologically treated to remove contaminants known as biological, soluble chemical oxygen demand through consumption by aerobic bacteria. The influent stream 10 is received from a primary treatment portion of the facility in which suspended solids are removed from the wastewater in primary clarifiers. The treatment of the influent stream 10 produces an effluent stream 12 that can be subsequently treated in a tertiary treatment process.

Apparatus 1 contains a selector aeration tank 14 from which an effluent thereof is fed as a stream 16 to a main aeration tank 18. As known in the art, selector aeration tank 14 can be several of such tanks and both the selector aeration tank 14 and the main aeration tank 18 could be portions of the same tank separated from one another by baffles. The purpose of the selector aeration tank 14 is to create conditions for the consumption of the biological, soluble chemical oxygen demand contained in the influent stream 10 that will promote the formation of floc forming bacteria that will rapidly settle within a subsequent secondary clarification tank 20 as opposed to filamentous forms of bacteria that will not settle quickly and thereby produce bulking conditions. The production of floc forming bacteria will allow for the production of the effluent stream 12 and result in a deposit containing live aerobic bacteria known as activated sludge 22. A recycle activated sludge stream 24 is recirculated back to the main aeration tank 18 and the selector aeration tank 14 as first and second subsidiary recycle activated sludge streams 26 and 28 that are composed of the activated sludge 22 to provide bacterial activity to the main aeration tank 18 and the selector aeration tank 14. Periodically, a waste activated sludge stream 29 is discharged for further treatment involving removal of water and phosphates as well as the reduction of the pathogenic content of the bacteria. Aerobic conditions are maintained for the bacterial activity by the injection of oxygen into the selector aeration tank 14 and the main aeration tank 18 by way of a first oxygen containing stream 30 that is injected into the selector tank 14 and a second oxygen containing stream 32 that is injected into the main aeration tank. Each of these oxygen containing streams preferably contain at least 90.0 percent by volume of oxygen.

As will be discussed, the process being conducted in apparatus 1 is controlled. The maintenance of aerobic conditions are controlled by control valves 34 and 36 that control the flow rate of first oxygen containing stream 30 and second oxygen containing stream 32. The flow rate of the first and second subsidiary recycle activated sludge streams 26 and 28 is controlled by means of control valves to control bacterial activity within the main aeration tank 18 and the selector aeration tank 14. Bacterial activity within the selector tank 10 is also controlled by means of a bypass stream 38 that contains a part of the influent stream 10 that bypasses the selector tank 14 and flows into the main aeration tank 18. Flow control of the bypass stream 38 is provided by a control valve 40.

The oxygen concentration within mixed liquor contained in the selector aeration tank 14 and the main aeration tank 18 is controlled by measurement of oxygen concentration with the use of oxygen sensors 42 and 44. Signals referable to the sensed oxygen concentration are transmitted from the oxygen sensors 42 and 44 by electrical conductors 46 and 48, respectively, to a controller 50. Controller 50 is programmed to maintain the oxygen concentration within set points by transmitting control signals through electrical conductors 52 and 54 to control valve 34 and 36, respectively. The set points are both preferably 2.0 mg./L (“milligrams per liter”). When the set points are reached, valves 34 and 36 either closed or are reset in a position at which the oxygen is delivered at a slower flow rate. The set points are preferably greater than 1.0 mg./L and will typically be set at 2.0 mg./l as mentioned above.

As mentioned above, conditions within the selector aeration tank 14 are maintained that will promote the production of floc forming bacteria and thereby prevent bulking. Among these conditions is the maintenance of a food to mass ratio that will promote the growth of floc forming bacteria. However, this alone will not guarantee an absence of bulking because if not enough biodegradable soluble chemical oxygen demand is absorbed by the bacteria within the selector aeration tank 14, then the excess will flow into main aeration tank 18 where it can promote the growth of filaments within the main aeration tank 18 and therefore bulking within the secondary clarifier tank 20. Furthermore, excess biodegradable soluble chemical oxygen demand within the selector aeration tank 14 will also favor the growth of zooglea which can also produce bulking.

Thus, as a first operational step of the present invention, the degree to which the biodegradable, soluble chemical oxygen demand is absorbed by bacteria in the selector aeration tank 14 is measured as a percentage of the total biodegradable, soluble chemical oxygen demand removed by the apparatus 1. This percentage should be between 50.0 and 85.0 percent and preferably 60.0 percent. It is understood that in these measurements, the soluble chemical oxygen demand is a fraction of the total chemical oxygen demand and the total biodegradable, soluble chemical oxygen demand is the soluble chemical oxygen demand that is removed by the apparatus 1. Thus a difference between soluble chemical oxygen demand in influents and effluents represents a sound basis for estimate the biodegradable soluble chemical oxygen demand removal. The biodegradable soluble chemical oxygen demand removed in the selector aeration tank 14 can be determined by filtering a sample obtained from the influent stream 10 within a 0.45 micron filter and measuring the filtrate to obtain a first soluble chemical oxygen demand concentration in units of, for instance, milligrams per liter. A second soluble chemical oxygen demand concentration can be determined by obtaining a sample of mixed liquor within the selector aeration tank 14 and then filtering the sample in a 0.45 micron filter. The biodegradable soluble chemical oxygen demand removed in the selector tank is therefore, a difference between the flow of the influent stream 10 actually entering the selector aeration tank 14 multiplied by the first soluble chemical oxygen demand concentration and the flow of the effluent leaving the selector aeration tank 14 multiplied by the second soluble chemical oxygen demand concentration. The flow of the influent stream 10 actually entering the selector aeration tank 14 is the difference between the flow rate of the influent stream 10 and the bypass stream 38. The flow of the effluent from the selector aeration tank 14 is the sum of the flow of the influent stream 10 actually entering the selector aeration tank 14 and the recycle activated sludge stream 28 because the flow out of the selector aeration tank 14 must equal the flow into the selector aeration tank 14. The total biodegradable, soluble chemical oxygen demand removed by the apparatus 1 is calculated by obtaining a sample of the effluent stream 12 and then filtering the same within a 0.45 micron filter and then measuring the filtrate to obtain a third soluble chemical oxygen demand concentration. A difference between the first soluble chemical oxygen demand concentration and the second soluble chemical oxygen demand concentration multiplied by the flow rate of the influent stream 10 is therefore, the total biodegradable soluble chemical oxygen demand removed by apparatus 1. The percentage removal of the biodegradable soluble chemical oxygen demand removed in the selector aeration tank 14 is thus, the ratio of the mass of the biodegradable soluble chemical oxygen demand removed in the selector aeration tank 14 and the total mass of soluble chemical oxygen demand removed by the apparatus 1 calculated in a manner set forth above. It is understood, however, that more direct measurements could be employed involving laboratory scale testing as known in the art.

Once the percentage removal of the soluble chemical oxygen demand in the selector aeration tank 14 is assured, the bio-oxidation level of the biodegradable soluble chemical oxygen demand in the selector aeration tank 14 is calculated through the use of a surrogate namely, the temperature corrected specific oxygen uptake rate. This can be done automatically through periodic measurement of the oxygen uptake rate, which is periodically measured within the selector aeration tank 14 by measuring a rate of change in a decrease in the oxygen concentration that is brought about by consumption of the oxygen by the bacteria. Preferably, this is done by allowing the oxygen concentration to increase to a level of 3.0 mg/L as measured by oxygen sensor 42 and then closing control valve 34. The rate of change is then measured. This rate of change will typically be measured in units of mg O2/L/hr (“oxygen per liters per hour”). Next with the use of the of the transducer 54, the mixed liquor suspended solids concentration in the selector aeration tank 14 is measured and converted to a value for the mixed liquor volatile suspended solids concentration by multiplying the sensed mixed liquor suspended solids value sensed by transducer 54 by a predetermined characteristic volatile suspended solids to suspended solids ratio for the plant. This predetermined characteristic ratio is determined from measurements obtained by taking a sample of mixed liquor from the selector, filtering it and heating the retained solids to 105° C. and 550° C. successively. The mass remaining after heating at 105° C. for 1 hour is the mixed liquor suspended solids (MLSS), while the fraction of the mixed liquor that is volatilized or lost, after heating MLSS at 550° C. for 15 minutes in a muffle furnace, is the organic volatile fraction of the mixed liquor suspended solids, hence it is referred to as the mixed liquor volatile suspended solids (MLVSS). The characteristic ratio is obtained by dividing the obtained value of MLVSS by the MLSS. The specific oxygen uptake rate is then determined by dividing the oxygen uptake rate by the mixed liquor volatile suspended solids. The temperature corrected specific oxygen uptake rate is determined by measuring temperature with a temperature transducer 56 of the mixed liquor within the selector aeration tank 14 and then multiplying the mixed liquid volatile suspended solid value by a Van't Hoff-Arrhenius temperature correction. The resulting temperature corrected specific oxygen uptake rate should be maintained at a level of between 18.0 and 27.0 milligrams oxygen per gram of volatile suspended solids per day at 20° C.

As mentioned above, although the foregoing measurement of temperature corrected specific oxygen uptake rate can be done in a laboratory scale sample, it preferably is done automatically by appropriate programming of controller 50. In this regard, signals referable to the temperature and mixed liquor suspended solids are transmitted to controller 50 by means of electrical connections 58 and 60, respectively. The Controller 50 then suspends oxygen delivery by means of closure of valve 34 once an elevated dissolved oxygen level is reached of preferably 3.0 mg/L. The oxygen uptake rate is computed along with a value of the mixed liquor volatile suspended solids on the basis of characteristic ratio preprogrammed into controller 50. The specific oxygen uptake rate is then calculated and corrected for temperature by Van't Hoff-Arrhenius temperature correction. Another possibility for determining the temperature corrected specific oxygen uptake rate is by measuring the specific oxygen uptake rate as set forth above and then determining the temperature corrected value based on a pre-programmed lookup table with interpolation as necessary based upon the measured temperature.

The control of the percentage removal of the biodegradable soluble chemical oxygen demand and the temperature corrected specific oxygen uptake rate in response to changing conditions of the influent stream 10 is accomplished by manipulation of control valve 40 to control the flow rate of the bypass stream 38 and control valves 62 and 64 to control the flow rates of the first and second subsidiary recycle activated sludge streams 26 and 28. Control valves 62 and 64 are remotely activated through electrical connections 66 and 68 to controller 50. When either the percentage removal of the biodegradable soluble chemical oxygen demand or the temperature corrected specific oxygen uptake rate is below either of their respective targeted ranges, the flow rate of the bypass stream 38 is reduced by successive closure of control valve 40. Alternatively, when the percentage removal or the temperature corrected specific oxygen uptake range are above their respective targeted ranges, the flow rate of the first subsidiary recycle activated sludge stream 26 is increased while decreasing the flow rate of the second subsidiary recycle activated sludge stream 28 by successively opening valve 62 and closing valve 64. It is to be noted that measurement of the percentage removal of the biodegradable soluble chemical oxygen demand and the exercise of control through control valves 62 and 64 would preferably take place every day or after each known process change that could impact the composition of the influent wastewater. The measurement of temperature corrected specific oxygen uptake rate and its control preferably takes place every day or after each known process change that could impact the composition of the influent wastewater. After each control action involving manipulation of the control valve 40 or the manipulation of control valves 62 and 64, preferably a solids loading rate and a hydraulic loading rate within the clarifier are measured. This is preferably done as a cross-check on the control and to determine whether a danger exists that bulking may occur. The solids loading rate is obtained by multiplying the total flow to the clarifier (i.e., the total influent 10 flow plus the total recycle activated sludge 24) by the mixed liquor suspended solids concentration in the main aeration tank; and dividing the result by the total surface area of the clarifier. The hydraulic loading rate is determined by dividing the total flow to the clarifier by the surface area of the clarifier. The solids loading and hydraulic loading rates have units of lbs/day/ft² [or kg/day/m²] and gpd/ft² [or m³/day/m²] respectively. A volumetric loading rate (with units of m³/m²/day) can be further defined from the solids loading rate by multiplying the solids loading rate (kg/day/m²) by the SVI (m³/kg). If it is determined that the solids and hydraulic loading rates are exceeded then a total flow rate of recycled activated sludge from the clarifier 20 to the main aeration tank 18 and the selector aeration tank 20 can be reduced, preferably in an amount of 10 percent. In this regard, flow rates of the first recycle activated sludge stream 26 and the second recycle activated sludge stream 28 can be inferred by the positions of the control valves 62 and 64 controlling these respective flows.

It is understood that controller 50 may be a remote primary controller that would allow for the manual, remote activation of valves in response to indications of valve position, oxygen, suspended solids concentration and temperature as sensed by oxygen transducers 42 and 44, suspended solids transducer 54 and temperature transducer 42. Such control would be used in the computation of the percentage removal of biodegradable soluble chemical oxygen demand and the control thereof to obtain the required percentage removal in that some laboratory analysis would be required. However, automated control using programmable control logic functions available in such primary controllers would be used for manipulation of control valves 34 and 36 and the maintenance of aerobic conditions within the selector aeration tank 14 and the main aeration tank 18. Further, the control of control valves 40, 62 and 64 could also be automated with respect to the maintenance of temperature corrected specific oxygen uptake rate. In this regard, a programmable controller would preferably also use proportional, integral and derivate control in connection with such automated control.

While the present invention has been described with reference to a preferred embodiment, as will occur to those skilled in the art, numerous changes, additions and omissions can be made without departing from the spirit and scope of the present invention as set forth in the appended claims.

We claim:

1. A method of operating a waste water treatment facility to prevent bulking in a clarifier used in discharging a treated effluent, said method comprising:
maintaining aerobic conditions for bacterial activity within a selector aeration tank and a main aeration tank, both located upstream of the clarifier from which activated sludge is recycled to the selector aeration tank and the main aeration tank to promote bacterial activity and a treated effluent is discharged;
promoting formation of floc forming bacteria and therefore, sufficient settling of solids in the clarifier to allow for the discharge of the treated effluent, by maintaining an absorption level and a bio-oxidation level of biodegradable, soluble chemical oxygen demand within the selector aeration tank that will promote the formation of the floc forming bacteria;
measuring the absorption level by measuring removal of biodegradable soluble chemical oxygen demand in the selector aeration tank as a percentage removal of the total biodegradable soluble chemical oxygen demand removed in both the selector aeration tank and the main aeration tank;
measuring the bio-oxidation level of the biodegradable soluble chemical oxygen demand by measuring temperature within mixed liquor contained in the selector aeration tank and the specific oxygen uptake rate within the selector aeration tank and correcting the specific oxygen uptake rate for non-standard temperature to obtain a temperature corrected specific oxygen uptake rate; and
maintaining the percentage removal of the total biodegradable soluble chemical oxygen demand and thereafter, the temperature corrected specific oxygen uptake rate within respective targeted ranges of between 50.0 percent and 85.0 percent for the percentage removal and between 18.0 and 27.0 milligrams oxygen per gram of volatile suspended solids per day at 20° C. for the temperature corrected specific oxygen uptake rate by:
deceasing a by-pass flow rate of wastewater influent bypassing the selector aeration tank in favor of the main aeration tank when either of the percentage removal or the temperature corrected specific oxygen uptake rate is below either of the respective targeted ranges; and
increasing a first recycle flow rate of activated sludge from the clarifier to the main aeration tank while decreasing a second recycle flow rate of the activated sludge from the clarifier to the selector aeration tank when either the percentage removal or the temperature corrected specific oxygen uptake rate is above either of the respective targeted ranges.

2. The method of claim 1 wherein the target range for the percentage removal rate is between 60.0 percent and 85.0 percent.

3. The method of claim 2, wherein after each modification of either the by-pass flow rate of wastewater influent or the first recycle rate flow rate and the second recycle flow rates, a solids loading rate and a hydraulic loading rate within the clarifier are measured and a total flow rate of recycled activated sludge from the clarifier to the main aeration tank and the selector aeration tank is reduced when the solids loading rate and the hydraulic loading rate are exceeded.

4. The method of claim 1 or claim 3, wherein the temperature corrected specific oxygen uptake rate is measured by:
measuring an oxygen uptake rate and mixed liquor suspended solids value within the selector aeration tank;
calculating a mixed liquor volatile suspended solids value within the selector aeration tank by multiplying the mixed liquor suspended solids value by a measured ratio of volatile suspended solids to total suspended solids;
calculating a specific oxygen uptake rate within the selector aeration tank by dividing the oxygen uptake rate by the mixed liquor volatile suspended solids value; and
applying a temperature correction for environmental temperature variation to the specific oxygen uptake rate.

5. The method of claim 4, wherein the specific oxygen uptake rate is corrected for the environmental temperature variation by measuring temperature of the mixed liquor within the selector aeration tank and multiplying the mixed liquid volatile suspended solid value by a Van't Hoff-Arrhenius temperature correction.

6. The method of claim 5, wherein the removal of biodegradable soluble chemical oxygen demand in the selector aeration tank as a percentage removal of the total biodegradable soluble chemical oxygen demand removed in both the selector aeration tank and the main aeration tank is measured by:
separately sampling an filtering an influent stream into the wastewater treatment facility, mixed liquor within the selector aeration tank and the treated effluent stream discharged from the secondary clarifier to respectively obtain, first, second and third soluble chemical oxygen demand concentrations;
determining the biodegradable soluble chemical oxygen demand removed in the selector aeration tank by multiplying flow rates of a portion of the influent stream actually entering the selector aeration tank and an effluent discharged from the selector aeration tank by the first and second of the soluble chemical oxygen demands;
determining the biodegradable soluble chemical oxygen demand removed in the wastewater treatment facility by multiplying a difference between the first and third of the soluble chemical oxygen demand concentrations by a further flow rate of the influent stream; and
calculating the percentage removal of the biodegradable soluble chemical oxygen demand in the selector by dividing the biodegradable soluble chemical oxygen demand removed in the selector aeration tank by the biodegradable soluble chemical oxygen demand removed in the wastewater treatment facility.

7. The method of claim 6 wherein aerobic conditions are maintained by:
injecting a first oxygen containing stream into the selector aeration tank and a second oxygen containing stream into the main aeration tank, the first oxygen containing stream and the second oxygen containing stream each containing at least 90.0 percent by volume oxygen;
measuring a first dissolved oxygen concentration in the selector aeration tank and a second dissolved oxygen concentration in the main aeration tank;
suspending or reducing injection rate of the first oxygen containing stream when the first dissolved oxygen concentration is greater than 1.0 mg/L; and
suspending or reducing injection of the second oxygen containing stream when the second dissolved oxygen concentration is greater than 1.0 mg/L.

8. The method of claim 7, wherein the oxygen uptake rate is measured by
increasing the first dissolved oxygen concentration to 3.0 mg/L.;
suspending the injection of the first oxygen containing stream when the first dissolved oxygen concentration is at 3.0 mg/L.; and
measuring the rate of change of the first dissolved oxygen concentration relative to time.
